(19) United States
(12) Patent Application Publication
(10) Pub. No.: US 2009/0113016 A1
(43) Pub. Date: Apr. 30, 2009

(54) Managing email servers by prioritizing emails

(76) Inventors: Subhabrata Sen, New Providence, NJ (US); Patrick Haffner, Atlantic Highlands, NJ (US); Oliver Spatscheck, Randolph, NJ (US); Shobha Venkataraman, Pittsburgh, PA (US)

Correspondence Address: AT&T CORP., ROOM 2A207, ONE AT&T WAY, BEDMINSTER, NJ, 07921, US

(21) Appl. No.: 11/977,243

(22) Filed: Oct. 24, 2007

(51) Int. Cl. G06F 15/16

(52) U.S. Cl. 709/207

(57) ABSTRACT

Disclosed are email server management methods and systems that protect the ability of the infrastructure of the email server to process legitimate emails in the presence of large spam volumes. During a period of server overload, priority classes of emails are identified, and emails are processed according to priority. In a typical embodiment, the server sends emails sequentially in a queue, and the queue has a limited capacity. When the server nears or reaches that capacity, the emails in the queue are analyzed to identify priority emails, and the priority emails are moved to the head of the queue.

### FIELD OF THE INVENTION

This invention relates to systems and methods for prioritizing emails during periods of overload in an email server. More specifically, it involves sorting emails to establish one or more priority email classes, and queuing emails by priority class during periods of email server overload.

### BACKGROUND OF THE INVENTION

Email has emerged as an indispensable and ubiquitous means of communication and is arguably one of the “killer” applications on the Internet. In many businesses, emails are at least as important as telephone calls, and in private communication emails have replaced writing letters by a large extent. Unfortunately, the utility of email is increasingly diminished by an ever larger volume of spam requiring both mail server and human resources to handle.

Considerable effort has focused on reducing the amount of spam an email user will receive. Most Internet Service Providers (ISPs) operate some type of spam filtering to identify and remove spam emails before they are received by the end-user. Email software on an end-user's PC might add an additional layer of filtering to remove this unwanted traffic based on the typical email patterns of the end-user.

On the other hand, there has been less attention paid to how these large volume of spam messages impact the ISP mail infrastructure which has to receive, filter and deliver mail appropriately. Spam is typically sent from zombies, and to a smaller extent, from open mail relays. Since zombie networks are very large, the spam that an attacker can generate is extremely elastic. The attacker can easily generate far many more messages per second than even the largest mail server can receive or process. However, the spammer has no interest in crashing a mail server since that would prevent the spam emails from being delivered. At the same time, there is a clear incentive to send large volumes of spam—the more spam a spammer sends the more likely it is that some of the spam will penetrate the spam filters deployed by ISPs. Given these observations, it is unsurprising that spammers would try to maximize the amount of spam they send by increasing the load on the mail infrastructure to a point at which the most spam will be received. In fact, this has been observed on mail servers of large ISPs. Mail servers typically respond to overloads by dropping emails at random. If the spammer increases the spam volume, more spam is likely to get accepted by the mail server. Thus, the spammer's optimal operation point is not the maximum capacity of the mail server, but the maximum load before the mail server will crash. This indicates that the approach of throwing more resources at the problem does not work in this case: increasing the mail server capacity will not work, unless it can be increased to a point larger than the largest botnet available to the spammer. This is typically not economically feasible, and so a different approach is needed.

While it is not the objective of spammers to overload the server, overload conditions in servers do occur as the result of large spam volume, and result in denial of service (DoS) for at least some users. DoS events may also occur as the result of deliberate overloads caused by one or more malicious users. These are referred to as DoS attacks. Small email servers, serving, for example, local area networks (LANS) are especially susceptible to DoS attacks.

### BRIEF STATEMENT OF THE INVENTION

We have designed systems, and operation of systems, that prevent or reduce either of these forms of DoS. In the primary case, these protect the ability of the infrastructure of an email server to process legitimate emails in the presence of large spam volumes. They operate by identifying priority classes of emails, and processing emails according to priority during a period of server overload. In this description, this operation will be referred to as priority sorting. In one embodiment, priority sorting is invoked by the server when the server volume is at or near capacity. In this embodiment, the server sends emails sequentially in a queue, and the queue has a limited capacity. When the server nears or reaches that capacity, the emails in the queue are analyzed to identify priority emails, and the priority emails are moved to the head of the queue.

In another embodiment, which recognizes that once the tools for implementing priority sorting are in place for use during overload conditions, the option exists for operating the server using priority sorting during normal (non-overload) conditions as well.

To implement priority sorting, it is necessary to invoke one or more methods for identifying priority email. The priority email is classified here as legitimate email, and can be categorized by identifying the legitimate email directly, or by deriving the legitimate email by identifying and separating out spam, or combinations of both.

### BRIEF DESCRIPTION OF THE DRAWING

The invention may be better understood when considered in conjunction with the drawing in which:

FIG. 1 is a plot of daily email volume vs. attempted SMTP connection, attempts received, emails where SpamAssassin™ is applied, and non-spam messages;

FIG. 2 shows cumulative distribution function (CDF) of the spam ratios of individual IPs:

FIG. 3 is a plot of legitimate emails sent vs. IP spam-ratio;

FIG. 4 is a plot of spam emails sent vs. IP spam-ratio;

FIG. 5 is a plot of the persistence in days of IP addresses;

FIG. 6 is a plot of the persistence in days of good IP addresses;

FIG. 7 is a plot of the persistence in days of IP addresses;

FIG. 8 is a plot of the persistence in days of spam IP addresses;

FIG. 9 shows the CDF of the frequency-fraction excess for several good k-sets;

FIG. 10 shows the fraction of spam sent by spam IP addresses and spam clusters;

FIG. 11 is a plot similar to FIG. 10 for legitimate email; and

FIGS. 12 and 13 show persistence of network-aware clusters. FIG. 12 shows spam and FIG. 13 shows legitimate emails.

### DETAILED DESCRIPTION OF THE INVENTION

Most known spam control techniques use a form of blacklist. Various forms of whitelists have also been proposed, but whitelists are inherently restrictive and thus typically not widely used. However, we propose a new variation of a whitelist approach to address the problem of server overload.

The two main categories of emails discussed herein, i.e. legitimate emails and spam emails, are well known and easily recognized categories. Legitimate emails have information content and are sent usually once to a limited number of recipients. Spam emails typically have advertising content and are sent once or more than once to a large number of recipients, e.g. more than 50 recipients. In between there is a significant volume of email that is legitimate but sent to a large number of recipients, e.g. inter-company alerts, subscriber lists, etc., as well as a significant volume of spam that may initially be sent to a relatively limited number of relay recipients (e.g. zombies, i.e, computers of innocent users that are co-opted by a spam sender to relay spam to an innocent user's address list). The objective of the invention is to identify a class of legitimate emails with a relatively high confidence level. These are defined as “priority” emails.

The focus of the invention is a technique to protect the ability of mail server infrastructure to process legitimate emails in the presence of large spam volumes. The goal is to increase the amount of legitimate mail that the server processes when under overload, and gain a performance improvement over the current approaches of dropping mail at random.

To address this problem specifically, incoming emails are dropped selectively during overload situation. The selection process may be viewed from two related but distinct perspectives. One, the selected emails may be emails that are identified, with a high level of confidence, as spam, or: two, emails that are identified, with a high level of confidence, as legitimate emails. The email queue in the server is modified in the first case by dropping the spam emails from the queue, or in the second case by moving the legitimate emails to the front of the queue. The result in terms of averting an overloaded server is qualitatively the same. But the selection process may be different.

It should be understood that since the goal is to maximize legitimate mail during overload, the priorities resulting from the selection process are different from regular spam-filtering. Spam filtering methods attempt to identify all spam. The approach here only requires identification of a significant portion of spam. Thus the selection process used here is much less demanding, and therefore less costly, than most spam filtering programs.

Likewise, if the selection process is aimed at identifying legitimate emails that selection may be inexact also. The precision of the two selection approaches can be expressed in general as:
1. Identify SOME of the spam email, or
2. Identify ALL of the legitimate email, but since this identification can include SOME of the spam email, the selection need not be exact.

To implement the inexact selection processes just mentioned, past historical behavior of IP addresses that send email is used to predict the likelihood of an incoming email being legitimate or spam, and of using IP-address reputations to drive the selective drop policy. This is referred to as “reputation”. The advantages of an IP-address reputation based filtering scheme are the ease of which the information can be collected, and the difficulty a spammer faces to hide the IP address of the zombie or open mail relay s/he utilizes. Obviously, using the IP address for classification is substantially cheaper then any content-based scheme. In fact, IP address based prioritization can even be implemented on modern routers or switches and can therefore be used to offload the processing of rejected senders from the mail server entirely. Further, IP based classification can be quite accurate, as demonstrated below. Consider that “good” mail servers, which are mail servers that try to actively block outgoing spam, typically belong to large organizations or ISPs, and rarely switch their IP address. On the other hand spammers mainly rely on botnets as well as poorly managed mail servers to relay their spam. Therefore, their IP addresses change more frequently, but stay within the IP prefix ranges. In some cases, these IP prefixes can be used as markers for compromised or poorly managed hosts. This leads to the hypothesis that good mail servers are mostly good and stay mostly good for a long time, and that bad prefixes send mainly spam and stay bad for a long time. If this hypothesis holds, the properties of both legitimate mail and spam can be used prioritize legitimate mail as needed.

To verify useful selection processes, an extensive measurement study was performed to understand IP-based properties of legitimate mail and spam. With that data a simulation study was performed to evaluate how these properties can be used to prioritize legitimate mail when the mail server is overloaded. It was demonstrated that a suitable reputation-based policy has a potential performance improvement factor of 3 over the state-of-the-art, in terms of amount of legitimate mail accepted.

While a very significant quantity of spam comes from IP addresses that are ephemeral, a significant of the legitimate mail volume comes from IP addresses that last for a long time. This suggests that using the history of good IP addresses—IP addresses that send a lot of legitimate mail—can be used as a mechanism for prioritizing mail in spam mitigation. Such an approach would be complementary to the usual blacklisting approaches.

The analysis performed also explored so-called network-aware clusters as candidates that may exploit structure in the IP addresses. Results suggest that IP addresses responsible for the bulk of the spam are well-clustered. Clusters responsible for the bulk of the spam are very long-lived. This suggests that network-aware clusters may be used in place of individual IP addresses as a reputation scheme to identify spammers, many of whom are ephemeral. The cluster reputation selection process, while theoretically less exact than the IP address reputation process, is potentially easier and less expensive to implement.

Since spam is so pervasive, much effort has been expended in mitigating spam, and understanding the characteristics of spammers. Traditionally, the two primary approaches to spam mitigation have used content-based spam-filtering and DNS blacklists. Content-based spam-filtering software is typically applied at the end of the mail processing queue, and there has been a lot of research in content-based analysis, and understanding its limits. Content-based analysis has been proposed to rate-limit spam at the router. However, content-based analysis is expensive to implement, and in some cases raises privacy concerns. The invention described here does not consider content of mail, but rather focuses on the history and structure of the IP address.

DNS blacklists are another popular way to reduce spam. Studies on DNS blacklisting have shown that over 90% of the spamming IP addresses were present in at least one blacklist at their time of appearance. The invention described here involves selection that is complementary to blacklisting. The focus is to develop a whitelist of legitimate mail, typically using a reputation mechanism. Yet another approach to spam identification is a greylist process that delays incoming emails if recent emails from a mail server have been identified as spam, or if no history for a given mail server exists. In contrast, the selection methods recommended for use with the invention provide a more detailed analysis of how predictable the spam behavior of a mail server identified by an IP address is, using more up-to-date data. In some embodiments, the identification of good and bad mail servers is extended to clusters of IP addresses, and a continuum rather than a binary decision is used to accept or reject incoming mail.

Data developed for the analysis consists of traces from the mail server of a large company serving one of the corporate locations with approximately 700 mailboxes taken over a period of 166 days from January to June 2006. The location runs a PostFix mail server with extensive logging that records the following: (a) every attempted SMTP connection, with its IP address and time stamp (b) whether the connection was rejected, along with a reason for rejection, (c) whether the connection was accepted, results of the mail server's customized spam-filtering checks, and if accepted for delivery, the results of running SpamAssassin™.

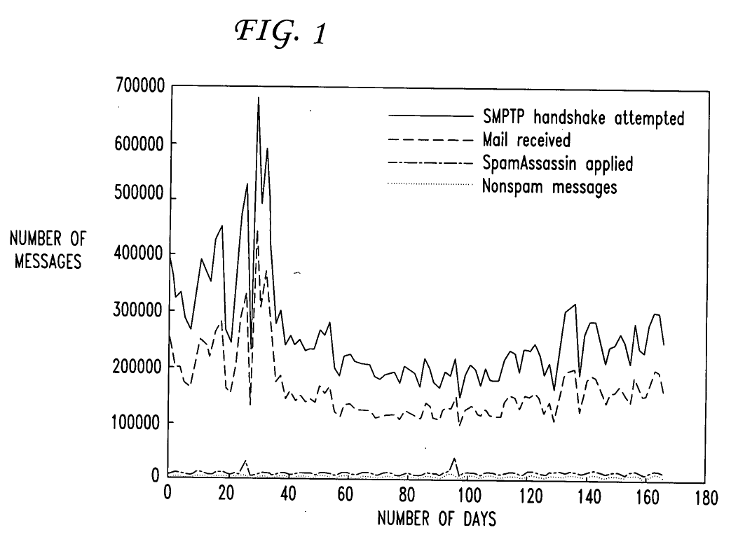

FIG. 1 shows a daily summary of the data for six months. It shows four quantities each day: (a) the number of SMTP connection requests made (including those that are denied via blacklists), (b) the amount of mail received by the mail server, (c) the number of e-mails that were sent to SpamAssassin, and (d) the number of e-mails deemed legitimate by SpamAssassin. The relative sizes of these four quantities every day illustrates the scope of the problem: the spam is 20 times larger than the legitimate mail received. (In our data set, there were 1.4 million legitimate messages and 27 million spam messages.) Such a sharp imbalance indicates the possibility of a significant impact for applications like rate-limiting under server overload: if there is a way to prioritize legitimate mail, the server can handle it much more quickly, because the volume of legitimate mail is tiny in comparison to spam. In the analysis that follows, every message that is considered legitimate by SpamAssassin is counted as a legitimate message; every message that is considered spam by SpamAssassin, the mail server's spam filtering checks, or through denial by a blacklist is counted as spam.

The behavior of individual IP addresses that send legitimate mail and spam can be analyzed with the goal of uncovering any significant differences in behavior patterns. The analysis focuses on the IP spam-ratio of an IP address, which is defined as the fraction of mail sent by the IP address that is spam. This is a simple, intuitive metric that captures the spamming behavior of an IP address: a low spam-ratio indicates that the IP address sends mostly legitimate mail; a high spam-ratio indicate that the IP address sends mostly spam. The goal is to see whether the historical communication behavior of IP addresses with similar spam-ratios yields clues to sufficiently distinguish between IP addresses of legitimate senders and spammers. As indicated earlier, the distinction between the legitimate senders and spammers need not be perfect; even with partially correct classification, benefit can be gained. For example, when all the mail cannot be accepted, a partial distinction would still help in increasing the amount of legitimate mail that is received. In the IP-based analysis, the following is addressed:
Distribution by IP Spam Ratio: What is the distribution of the number of IP addresses by their spam-ratio, and what fraction of legitimate mail and spam is contributed by IP addresses with different spam-ratios?
Persistence: Are IP addresses with low/high spam-ratios present in many days? If they are, do such IP addresses contribute to a significant fraction of the legitimate mail/spam?
Temporal Spam-Ratio Stability: Do many of the IP addresses that appear to be good on average fluctuate between having very low and very high spam-ratios?

The answers to these three questions, taken together, gives an indication of the benefit derived in using the history of IP address behavior for the selection process used in the invention.

Most IP addresses have a spam-ratio of 0% or 100% , but a significant amount of legitimate mail will come from IP addresses with spam-ratio exceeding zero. It is demonstrated below that a very significant fraction of the legitimate mail comes from IP addresses that persist for a long time, but only a small fraction of the spam comes from IP addresses that persist for a long time. It is also demonstrated below that most IP addresses have a very high temporal ratio-stability—they do not fluctuate between exhibiting a very low or very high spam ratio every day. Together, these three observations suggest that identifying IP addresses with low spam ratios that regularly send legitimate mail is useful in spam mitigation and prioritizing legitimate mail.

To understand how IP-based filtering using spam ratio is useful and what kind of impact it has, the distribution of IP addresses and their associated mail volumes are studied as a function of the IP spam-ratios. Intuitively, we expect that most IP addresses either send mostly legitimate mail, or mostly spam, and that most of the legitimate mail and spam comes from these IP addresses. If this hypothesis holds, then for spam mitigation it will be sufficient if the IP addresses are identified as senders of legitimate mail or spammers. To test this hypothesis, the following two empirical distributions are identified: (a) the distribution of IP addresses as a function of the spam ratios, and (b) the distribution of legitimate mail/spam as a function of the spam ratio of the respective IP addresses. The first experiment shows that most IP addresses are present at either ends of the spectrum of spam ratios, but the second experiment shows that the distribution of legitimate mail volume is not as focused at the ends of the spectrum. The spam-ratio computed over a short time period is studied to understand the behavior of IP addresses, without being affected by their possible fluctuations in time. The analysis is for intervals of a day to cover possible time-of-day variations.

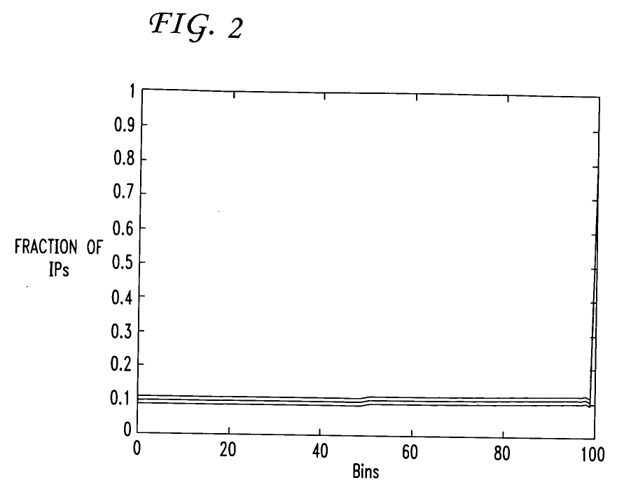

FIG. 2 depicts, for a large number of randomly selected days across the observation period, the daily empirical cumulative distribution function (CDF) of the spam ratios of individual IPs that sent some email to the server on that day. This shows that for nearly six months, on any particular day, (i) most IP addresses send either mostly spam or mostly legitimate mail. (ii) Fewer than 1-2% of the active IP addresses have a spam-ratio of between 1%-99% , ie., there are very few IP addresses that send a non-trivial fraction of both spam and legitimate mail. (iii) the vast majority (nearly 90% ) of the IP addresses on any given day generate almost exclusively spam, having spam-ratios between 99%-100%.

The above indicates that identifying IP addresses with low or high spam-ratios can identify most of the legitimate senders and spammers.

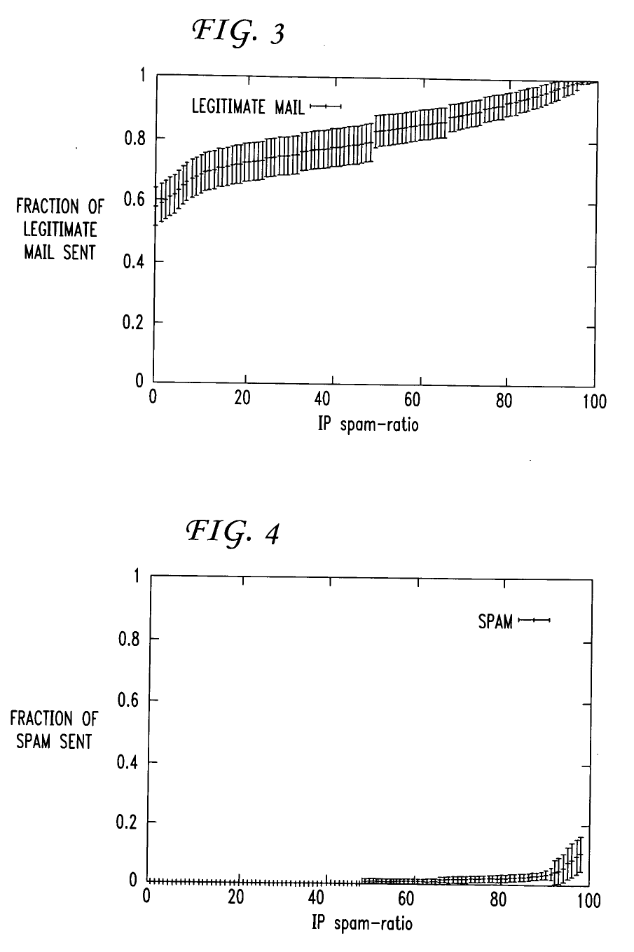

For some applications, it would also be valuable to identify the IP addresses that send the bulk of the spam or the bulk of the legitimate mail. An example is the server overload problem, where the goal is to accept as much of the legitimate mail volume as possible. The distribution of the daily legitimate mail or spam volumes as a function of the IP spam-ratios are identified. IP addresses that have a spam-ratio of at most k are categorized as set Ik. FIG. 3 shows how the volume of legitimate mail sent by the set Ik depends on the spam-ratio k. Specifically, let Li(k) and Si(k)be the fractions of the total daily legitimate mail and spam that comes from all IPs in the set Ik, on day i. FIG. 3 plots Li(k)averaged over all the days, along with confidence intervals. FIG. 4 shows the analogous plot for the spam volume Si(k).

These data show that the bulk of the legitimate mail (nearly 70% on average) comes from IP addresses with a very low spam-ratio (k≦5%). However, a modest quantity (over 7% on average) also comes from IP addresses with a high spam-ratio. (k≧80% ). It also shows that almost all (over 99% on average) of the spam sent every day comes from IP addresses with an extremely high spam-ratio (when k≧95% ). indeed the contribution of the IP addresses with a spam-ratios (k≦80% ) is a tiny fraction of the total.

We observe that there is a sharp difference in how the distribution of legitimate mail and spam contributions vary with the spam-ratio k: There are two possible explanations for this more diffused behavior of the legitimate senders. First, spam-filtering software tends to be conservative, allowing some spam to marked as legitimate mail. Second, a lot of legitimate mail tends to come from large mail servers that cannot do perfect outgoing spam-filtering. Together the above results suggest that the IP spam-ratio appears to be a useful discriminating feature for spam mitigation. Specifically, assume a classification function that accepts all IP addresses with a spam-ratio of at most k, and rejects all IP addresses with a higher spam-ratio. Then, if k is set=95% , nearly all of the legitimate mail is accepted, and no more than 1% of the spam. The effectiveness of such a history-based classification function for spam mitigation depends both on the extent to which IP addresses are long lasting, how much of the legitimate email or spam are contributed by the long lasting IP addresses, and to what extent the spam ratio of an IP address varies over time. These effects are examined next.

To understand how IP addresses can be identified as spammers or non-spammers, data is analyzed to determine whether there are legitimate long-term properties that can be exploited to differentiate between them. For example, it can be assumed that many of the IP addresses that send legitimate mail do so consistently, and a significant fraction of the legitimate mail is sent by these IP addresses. For this analysis, the spam ratio of each individual IP address is computed over the entire data set to show behavior over the lifetime of the address. Two properties are shown in this analysis: (i) IP addresses sending a lot of good mail last for a long time (persistence), and (ii) IP addresses sending a lot of good mail tend to have a bounded spam ratio each time they appear (temporal stability). These 2 properties directly influence the effectiveness of using historical reputation information for determining the “spaminess” of emails being sent by an individual IP address.

Due to the community structure inherent in non-spam communication patterns, it seems reasonable that much legitimate mail will originate from IP addresses that appear and re-appear. Studies have also indicated that most of the spam comes from IP addresses that are extremely short-lived. If these hypotheses hold, together they suggest the existence of a potentially significant difference in the behavior of senders of legitimate mail and spammers with respect to persistence.

This premise, and the quantifiable extent to which it holds, may be established by examining the persistence of individual IP addresses. The methodology proposed for understanding the persistence behavior of IP addresses is as follows: consider the set of all IP addresses with a low lifetime spam-ratio, and examine both how much legitimate mail they send, as well as how much of this is sent by IP addresses that are present for a long time. Such an understanding can indicate the potential of using a whitelist-based approach for mitigation in specified situations, like the server overload problem. If, for instance, the bulk of the legitimate mail comes from IP addresses that last for a long time, this property can be used to prioritize legitimate mail from long lasting IP addresses with low spam ratios. For this priority category the following definition is used:

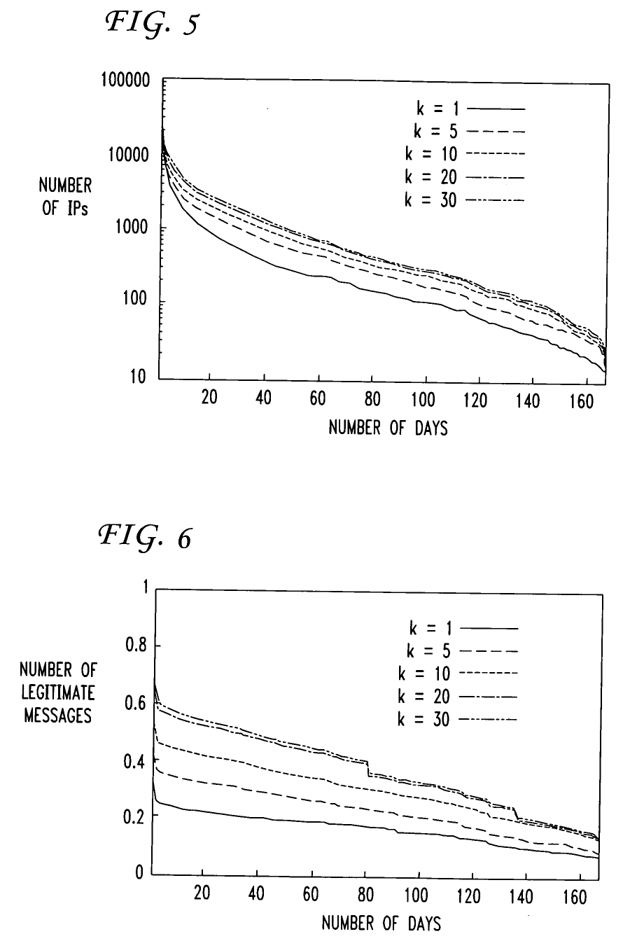

k-good IP address: an IP address whose lifetime spam-ratio is at most k.
A k-good set is the set of all k-good IP addresses.
   Thus, a 20-good set is the set of all IP addresses whose lifetime spam-ratio is no more than 20% . The number of IP addresses present in the k-good set for at least x distinct days is determined, as well as the fraction of legitimate mail contributed by IP addresses in the k-good set that are present in at least x distinct days. FIG. 5 shows the number of IP addresses that appear in at least x distinct days, for several different k, and drops by a factor of 10 to 2000 when x=10. FIG. 6 shows the fraction of the total legitimate mail that originates from IP addresses that are in the k-good set, and appear in at least x days, for each threshold k. Most of the IP addresses in a k-good set are not present very long, and the number of IP addresses falls quickly, especially in the first few days. However the contribution of IP addresses in a k-good set to the legitimate mail drops much more slowly as x increases. The result is that the few longer-lived IPs contribute to most of the legitimate mail from the a k-good set. For example, only 5% of all IP addresses in the 20-good set appear at least 10 distinct days, but they contribute to almost 87% of all legitimate mail for the 20-good set.

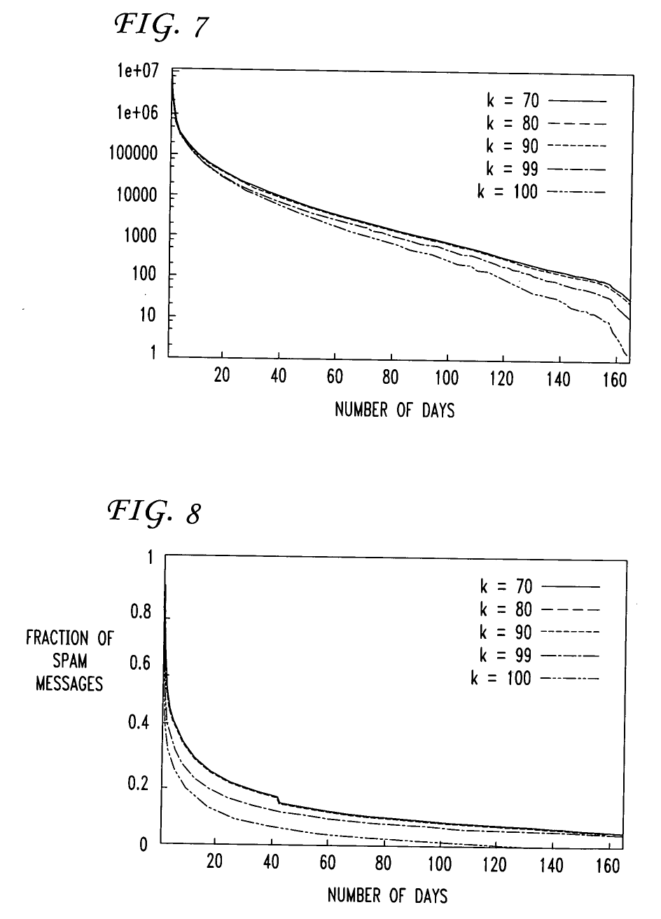

FIGS. 6 and 7 indicate that, overall, IP addresses with low lifetime spam ratios (small k) tend to contribute a major portion of the total legitimate email, while only a small fraction of the IP addresses with a low lifetime spam-ratio addresses that appear over many days, constitute a significant portion of the legitimate mail. For instance, IP addresses in the 20-good set contribute 63.5% of the total legitimate mail received. Only 2.1% of those IP addresses are present for at least 30 days, but they contribute to over 50% of the total legitimate mail received.

The graphs also suggest another trend: the longer an IP address lasts, the more stable its contribution to the legitimate mail. For example, 0.09% of the IP addresses in the 20-good set are for at least 60 days, but they contribute to over 40% of the total legitimate mail received. From this it can be inferred that an additional 1.2% of IP addresses in the 20-good set were present for 30-59 days, but they contributed only 10% of the total legitimate mail received.

FIGS. 7 and 8 present a similar analysis of persistence for IP addresses with a high lifetime spam-ratio. These are “bad” IP addresses and are defined as:
k-bad IP address: A k-bad IP address is an IP address that has a lifetime spam-ratio of at least k. A k-bad set is the set of all k-bad IP addresses.

FIG. 7 presents the number of IP addresses in the k-bad set that are present in at least x days, and FIG. 8 presents the fraction of the total spam sent by IP addresses in the k-bad set that are present in least x days.

FIGS. 7 and 8 show that, overall, IP addresses with high lifetime spam ratios (large k) tend to contribute almost all of the spam, and most of these high spam-rate IPs last only a short time and account for a large proportion of the overall spam. It also shows that the small fraction of these IPs that do last several days still contribute a significant fraction of the overall spam. Only 1.5% of the IP addresses in the 80-bad set appear in at least 10 distinct days, and these contribute 35.4% of the volume of spam from the 80-bad set, and 34% of the total spam. The difference is more pronounced for 100-bad IP addresses: 2% of the 100-bad IP addresses last for 10 distinct days, and contribute 25% of the total spam volume. As in the case of the k-good IP addresses, the volume of spam coming from the k-bad IP addresses tends to get more stable with time. The above results have an implication for the design of spam filters, especially for applications where the goal is to prioritize legitimate mail, rather than discard the spam. While the spamming IP addresses that are persistent can be blacklisted, the scope of a purely blacklisting approach is limited. On the other hand, a very significant fraction of the legitimate mail can be prioritized using the sender history of the legitimate mail.

The IP addresses in the k-good set can also be analyzed for temporal stability, i.e. is an IP address that appears in a k-good set (for small values of k) likely to have a high spam-ratio? The focus in this analysis is on k-good IP addresses; the results for the k-bad IP addresses are similar.

For each IP address in a k-good set, how often does the daily spam-ratio exceed k (normalized by the number of appearances). This quantity is defined as the frequency-fraction excess. The CDF of the frequency-fraction excess of all IP addresses in the k-good set is plotted. Intuitively, the distribution of the frequency-fraction excess is a measure of how many IP addresses in the k-good set exceed k, and how often.

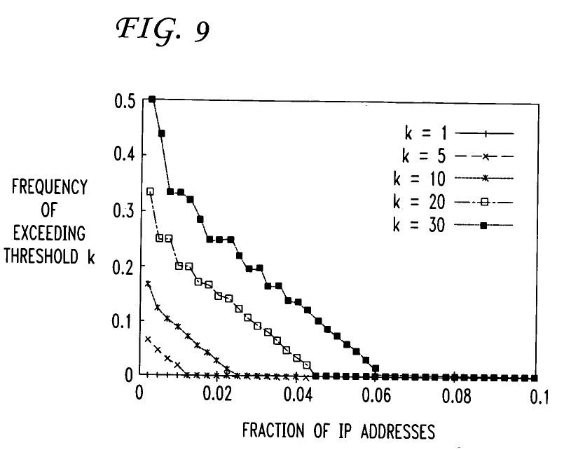

FIG. 9 shows the CDF of the frequency-fraction excess for several k-good sets. It shows that the majority of the IP addresses in each k-good set have a frequency-fraction excess of 0, and that 95% have a frequency fraction excess of at most 0.1. To understand the implication of this to the temporal stability of IP addresses, the k-good set for k=20 is analyzed. This is the set of IP addresses with a lifetime spam-ratio bounded by 20% . Note that the frequency-fraction excess of 0 for 95% of the IP addresses implies that 95% of IP addresses in this k-good set do not send more than 20% spam any day. Note that 4.75% of the IP addresses in this k-good set have a frequency-fraction excess between 0-20%, which implies that for 80% of their appearances, 99.75% IP addresses have a daily spam ratio bounded by k=20% .

FIG. 9 shows that for many k-good sets with small k-values, only a few IP addresses have a significant frequency-fraction excess. This implies that most IP addresses in each set do not exceed the value k. Since they would need to exceed k often to significantly change their spamming behavior, it follows that most IP addresses in the k-good set do not change spamming behavior significantly. In addition, the frequency-fraction excess is a strict measure, since it increases that even when k is exceeded slightly. Similarly, the measure that increases only when k is exceeded by 5% is computed. No more than 0.01% of IP address in the k-good set exceed k by 5%. Since the metric here is the temporal stability of IP addresses that last a long time, the frequency fraction-excess distribution for IP addresses that last 10, 20, 40 and 60 days is analyzed. In each case, almost no IP address exceeds k by 5% .

The conclusion from this is that of the IP addresses present in the 20-good set, fewer than 0.01% have a daily spam-ratio exceeding 25% on any day throughout their lifetime. Fewer than 1% of them have a daily spam-ratio exceeding 20% for more than one-tenth of their appearances. Thus most IP addresses in k-good sets do not fluctuate significantly in their spamming behavior; and most that appear to be good on an average are good every individual day as well. This result allows an analysis of the behavior of k-good sets of IP addresses, constructed over their entire lifetimes, and use of that analysis to understand implications to the behavior in the daily time intervals.

The analysis of these three properties of IP addresses indicates that a significant fraction of the legitimate mail comes from IP addresses that persistently appear in the traffic. These IP addresses tend to exhibit very stable behavior: they do not fluctuate significantly between sending spam and legitimate mail. However, there is still a significant portion of the mail that cannot be accounted for through the use of IP addresses only. These results lend weight to the hypothesis that spam mitigation efforts can benefit non-trivially by preferentially allocating resources to the stable and persistent senders of legitimate mail.

A limitation of reputation schemes based on historical behavior of individual IP addresses is that while they are able to discern IPs that appeared in the past, they may not be very useful in distinguishing between newcomer legitimate senders of spam or legitimate emails. To address this issue, the data can be analyzed to determine if there are coarser aggregations, other than individual IP addresses, that might exhibit more persistence, and afford more effective discrimination power for spam mitigation. The premise is that for IP addresses with little or no past history, their current reputation can be derived based on the historical reputation of the aggregation they belong to.

To implement this, network-aware clusters of IP addresses are used. Network-aware clusters are a set of unique network IP prefixes collected from a wide set of Border Gateway Protocol (BGP) routing table snapshots. An IP address belongs to a network-aware cluster if a prefix matches the prefix associated with the cluster. The motivation behind using network-aware clustering is that clusters represent IP addresses that are close in terms of network topology and, with high probability, represent regions of the IP space that are under the same administrative control and share similar security and spam policies. Thus they provide a mechanism for reputation-based classification of IP addresses.

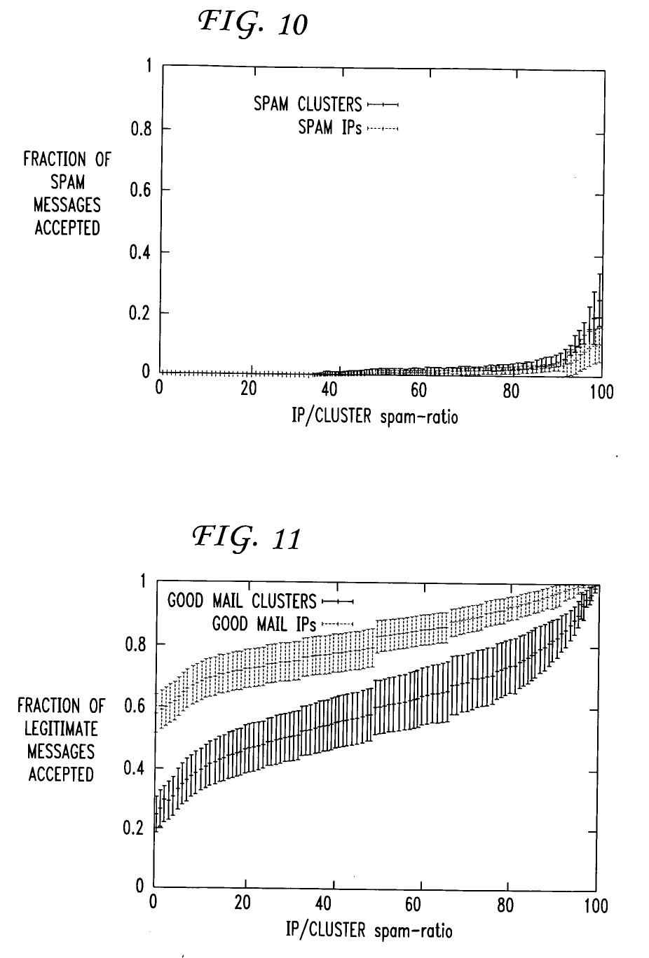

Analysis similar to that described above indicates that cluster spam-ratio is useful as an approximation of the IP spam-ratio described above. FIG. 10 shows how the volume of spam sent by IP addresses with a cluster or IP spam-ratio of at most k varies with k. Specifically, let C Si(k) and ISi(k) be the fraction of spam sent by the IP addresses with a cluster spam ratio (respectively IP spam ratio) of at most k on day i. FIG. 10 plots (i) C Si(k)and ISi(k) averaged over all the days in the data set, as a function of k, along with confidence intervals.

These data show that almost all (over 95%) of the spam every day comes from IPs in clusters with a very high cluster spam-ratio (over 90%). A similar fraction (over 99% on average). of the spam every day comes from IP addresses with a very high IP spam-ratio (over 90%). This suggests that spammers responsible for a high volume of the total spam may be closely correlated with the clusters that have a very high spam-ratio. The graph indicates that if we use a spam ratio threshold of k≦90% for spam mitigation, using the IP spam-ratio rather than their cluster spam-ratio as the discriminating feature, would identify less than 2% additional spam. This suggests that cluster spam-ratios are a good approximation to IP spam-ratios for identifying the bulk of spam sent.

Analogous to the earlier spam study, the distribution of legitimate mail according to cluster spam-ratios is considered. This is compared with IP spam-ratios in FIG. 11. Let C Li(k) and ILi(k) be the fraction of legitimate mail sent by IPs with a cluster spam-ratio and IP spam ratio respectively, of at most k. FIG. 11 plots C Li(k) and ILi(k) averaged over all the days in the data set, as a function of k, along with confidence intervals. FIG. 11 shows that a significant amount of legitimate mail is contributed by clusters with both low and high spam-ratios. A significant fraction of the legitimate mail (around 45% on average) comes from IP addresses with a low cluster spam-ratio (k≦20% ). However, a much larger fraction of the legitimate mail (around 70% , on average) originates from IP addresses with a similarly low IP spam-ratio.

These data reveal that with spam-ratios as high as 30-40%, the cluster spam-ratios only distinguish, on average, around 50% of the legitimate mail. By contrast, IP spam-ratios can distinguish as much as 70%. This suggests that IP addresses responsible for the bulk of legitimate mail are less correlated with clusters of low spam-ratio. However, FIG. 11 suggests that, if the threshold is set to 90% or higher, a relatively small penalty is incurred in both legitimate mail acceptance and spam.

However, there are two additional considerations. First, the bulk of the legitimate email comes from persistent k-good IP addresses. This suggests that more legitimate email can be identified by considering the persistent k-good IP addresses, in combination with cluster-level information. Second, for some applications, the correlation between high cluster spam-ratios and the bulk of the spam may be sufficient to justify using cluster-level analysis. For example, under the existing distribution of spam and legitimate mail, using a high cluster spam-ratio threshold would be sufficient to reduce the total volume of the mail accepted by the mail server. This has general implications for the server overload problem.

Similar to the study of IP addresses, persistence is also a useful means for evaluating network-aware clusters. A cluster is considered to be present on a given day if at least one IP address that belongs to that cluster appears that day. Earlier results showed that clusters were at least as (and usually more) temporally stable than IP addresses. As in the earlier IP address analysis, k-good and k-bad cluster categories are used, and are based on the lifetime cluster spam-ratio: the ratio of the total spam mail sent by the cluster to the total mail sent by it over its lifetime. These are defined specifically as:
A k-good cluster is a cluster of IP addresses whose lifetime cluster spam-ratio is at most k. The k-good cluster-set is the set of all k-good clusters.
A k-bad cluster is a cluster of IP addresses whose lifetime cluster spam-ratio is at least k. The k-bad cluster-set is the set of all k-bad clusters.

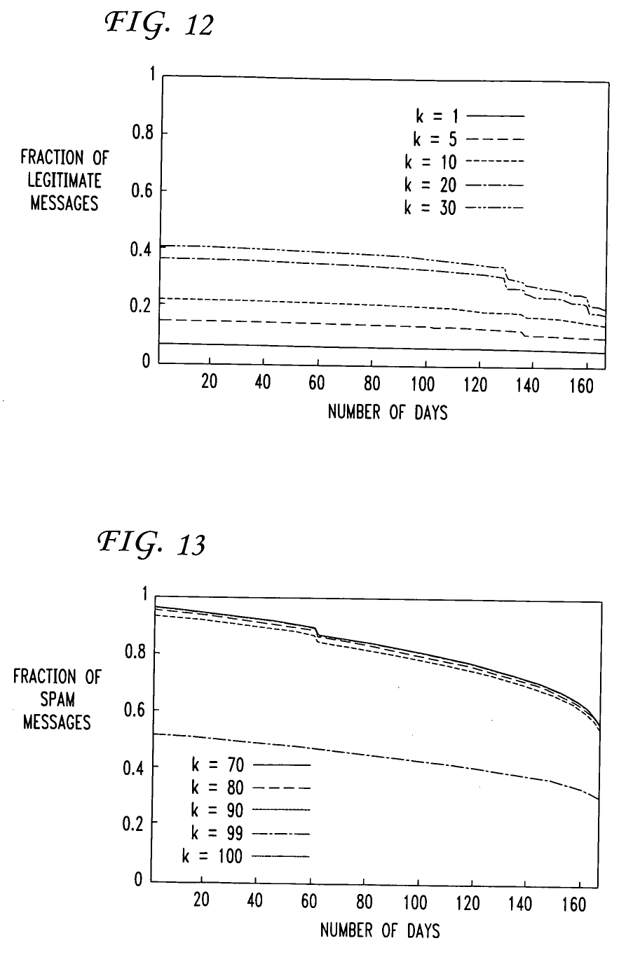

FIG. 12 examines the legitimate mail sent by k-good clusters, for small values of k. The k-good clusters, even when k=30% , contribute less than 40% of the total legitimate mail. However, the contribution from long-lived clusters is far more than from long-lived individual IPs. The difference from FIG. 6 is striking; indeed, k-good clusters (for all k) present for at least ten days contribute to almost 100% of total legitimate mail coming from k-good cluster-set. Further, k-good clusters present for at least 60 days contribute to nearly 99% of the legitimate mail from the k-good cluster set. This implies that any cluster accounting for a non-trivial volume of legitimate mail is present for at least 60 days. The legitimate mail volume drops to 90% of the total k-good cluster-set only in the case of clusters present for more than 120 days.

FIG. 13 presents the same analysis for k-bad clusters. Here, there are some striking differences from the k-good clusters. First, the 90-bad cluster-set contributes nearly 95% of the total spam volume. A much larger fraction of spam comes from long-lived clusters than from long-lived IPs (FIG. 8). For example, over 95% of the spam in the 90-bad cluster set is contributed by clusters present for at least 10 days. This is in sharp contrast to the k-bad IP addresses, where only 20% of the total spam volume comes from IP addresses that last 20 or more days. Thus it is demonstrated that long-lived clusters tend to contribute the bulk of both legitimate emails and spam, and that network-aware clustering can be used to address the problem of transience of IP addresses in developing history-based reputations of IP addresses.

Measurements show that senders of legitimate mail demonstrate stability and persistence, while spammers do not. However, the bulk of high volume spammers appears to be clustered within some network-aware clusters that persist very long. Together, this suggests a useful reputation mechanism based on the history of an IP address, and the history of a cluster to which it belongs. However, because mail rejection mechanisms should be conservative, such a reputation-based mechanism is primarily useful for prioritizing legitimate mail, rather than discarding suspected spammers.

An email server has a finite capacity of the number of mails that can be processed in any time interval, and may choose the connections it accepts or rejects. As indicated earlier, the goal of the invention is for the email server to selectively accept connections in order to maximize the legitimate mail accepted.

Email server overload is a significant problem. For example, assume an email server can process 100 emails per second, will start dropping new incoming SMTP connections when its load reaches 100 emails per second, and crashes if the offered load reaches 200 emails per second. Assume also that 20 legitimate emails are received per second. In such a scenario the spammer could increase the load of the mail server to 100% by sending 80 emails per second, all of which would be received by the email server. Alternatively, the spammer could also increase the load to 199% by offering 179 spam email per second, in which case nearly half the requests would not be served.

In summary, it is established above that there are history-based reputation functions that may be used for prioritizing email to address server overload issues. As is evident the target identifications are:
Identify legitimate email
Identify spam

Either identification may be derived from the other by subtraction, but the distinction is important since neither identification mechanism is expected to be exact. In the usual case, the nearer to perfection of either identification, the more likely the error. That is, for the case of most reputation functions, the confidence level for the identification category declines as the percentage increases.

In most cases of overload, it is sufficient to identify just enough spam to alleviate the overload condition. This may be done with a relatively high level of confidence. It is then not important if legitimate emails are identified at all.

In making the identification, characteristics of the emails are assessed. These may include:
IP addresses
IP clusters
IP addresses and IP clusters

In each case the characteristic may be evaluated according to:
email sending rate (emails per unit time)
persistence

In the preferred embodiment the email queue for the server is processed according to priority of the emails when the server queue reaches X % of server capacity C, where X is a threshold of, for example, 75 or above.

Various additional modifications of this invention will occur to those skilled in the art. All deviations from the specific teachings of this specification that basically rely on the principles and their equivalents through which the art has been advanced are properly considered within the scope of the invention as described and claimed.

1. Method for server management of email wherein the server receives X emails sequentially in an input queue, and sends E emails to email subscribers sequentially in an output queue, and the server queue has a capacity of C emails, comprising the steps of:
1) analyzing the emails to identify a class P of priority emails, where P is a fraction of X,
2) moving the P emails to the head of the E email queue.

2. The method of claim 2 wherein E is less than X.

3. The method of claim 2 wherein steps 1) and 2) are performed when X is approximately equal to C.

4. The method of claim 2 wherein steps 1) and 2) are performed when X is greater than 75% of C.

5. The method of claim 1 wherein the E emails comprise spam emails S and legitimate emails L.

6. The method of claim 5 wherein the P emails comprises L emails and a portion of S emails.

7. The method of claim 6 wherein the P emails are identified by identifying a least a portion of S emails, and subtracting the portion of S emails from E.

8. The method of claim 1 wherein the P emails are identified based on the reputation of emails.

9. The method of claim 8 wherein the reputation is based on IP address.

10. The method of claim 8 wherein the reputation is based on IP cluster identification.

11. The method of claim 8 wherein the reputation is based on both IP address and IP cluster identification.

12. The method of claim 1 wherein the P emails are identified based on the persistence of emails.

13. The method of claim 12 wherein the persistence is based on IP address.

14. The method of claim 12 wherein the persistence is based on IP cluster identification.

15. The method of claim 12 wherein the persistence is based on both IP address and IP cluster identification.
